(19) United States
(12) Patent Application Publication
(10) Pub. No.: US 2008/0095345 A1
(43) Pub. Date: Apr. 24, 2008

(54) Method of providing personalized music on hold to callers

(76) Inventors: Ranjan Sharma, New Albany, OH (US); Gregory Tevonian, North Aurora, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/583,313

(22) Filed: Oct. 18, 2006

(51) Int. Cl. H04M 3/42

(52) U.S. Cl. 379/201.01

(57) ABSTRACT

An apparatus and method are provided for generating music for a caller during a silent period of a call when the caller is placed on hold by a subscriber of a personalized music on hold system. The music is selected by the subscriber of a personalized music on hold system specifically for the caller based on a stored profile maintained by the subscriber. The music is terminated at the end of the silent period when the caller is no longer on hold.

### TECHNICAL FIELD

This invention relates to the art of music on hold systems, and more particularly to providing a network-based personalized music on hold system.

### BACKGROUND

For many businesses, placing telephone callers “on hold” is an unfortunate but unavoidable part of communications, because it may be impossible to assist everyone immediately. Many callers, who hear silence when placed on hold, hang up within a short time out of frustration or because the callers may believe that the call is no longer in process.

Music on Hold service allows telephone callers to a business to hear music and information during a silent period when a) the callers are placed on hold or b) the callers are being transferred during a call. Music on Hold lets the callers know that the call is still in process, and entertains the callers, which gives an impression that the time spent on hold is short. Thus, callers who receive music on hold will wait several minutes longer than callers on hold who hear silence.

Typically, prior art Music on Hold systems may be an adjunct to a Private Branch exchange (PBX) on the premises of a called business or other telephone equipment systems located on the premises of the called business. Disadvantageously, during a specific day and time, the prior art Music on Hold systems play the same music to all callers to businesses. Thus, the called businesses cannot distinguish between callers on hold to provide specific music for specific callers on hold. Also disadvantageously, called businesses cannot specify certain times and conditions, e.g., during work hours, during a lunch break, etc., for playing specific music on hold to specific callers. Further disadvantageously, the callers cannot specify a desired song or a desired music genre for their listening pleasure while on hold.

### SUMMARY

It has been recognized, in accordance with the principles of the invention, that the problems of the prior art can be overcome by a network-based personalized music on hold system. More specifically, the network-based personalized music on hold system customizes a listening experience for a caller to a business or residence by a) generating, during a silent period of a telephone call when a first telephone user has been placed on hold by a second telephone user, music for the first telephone user selected by the second telephone user based on a musical interest of the first telephone user; and b) terminating the music when the first telephone user is no longer on hold.

### DESCRIPTION OF THE DRAWINGS

FIG. 1 shows a network view of an illustrative embodiment of the present invention of a network-based personalized music on hold system;

FIG. 2 shows another network view of an illustrative embodiment of the present invention of the network-based personalized music on hold system;

FIG. 3 shows an illustrative stored profile of callers to a business that is a user of the network-based personalized music on hold system;

FIG. 4 shows an illustrative call flow for a method of operating the network-based personalized music on hold system; and

FIG. 5 shows another illustrative call flow for a method of operating the network-based personalized music on hold system.

### DETAILED DESCRIPTION

The present invention provides a network-based personalized music on hold system for communications service providers, e.g., a telephone company, a cable TV company, a wireless carrier, etc. Communications service providers may offer the network-based personalized music on hold system as a personalized music on hold service to business and residential subscribers. The personalized music on hold system assists a music on hold (MoH) subscriber, e.g., a business, a residential telephone subscriber, etc., in customizing a listening experience for callers by allowing the personalized MoH subscriber to select a music type, a music genre, and/or a music track chosen specifically for the callers to be played and listened to when the callers are placed on hold by the MoH subscriber. One or both parties, i.e., callers and called parties, on a call may be a personalized MoH subscriber and the personalized MoH subscriber(s) may place the other party, i.e., callers or called parties, on hold and initiate the personalized music on hold feature.

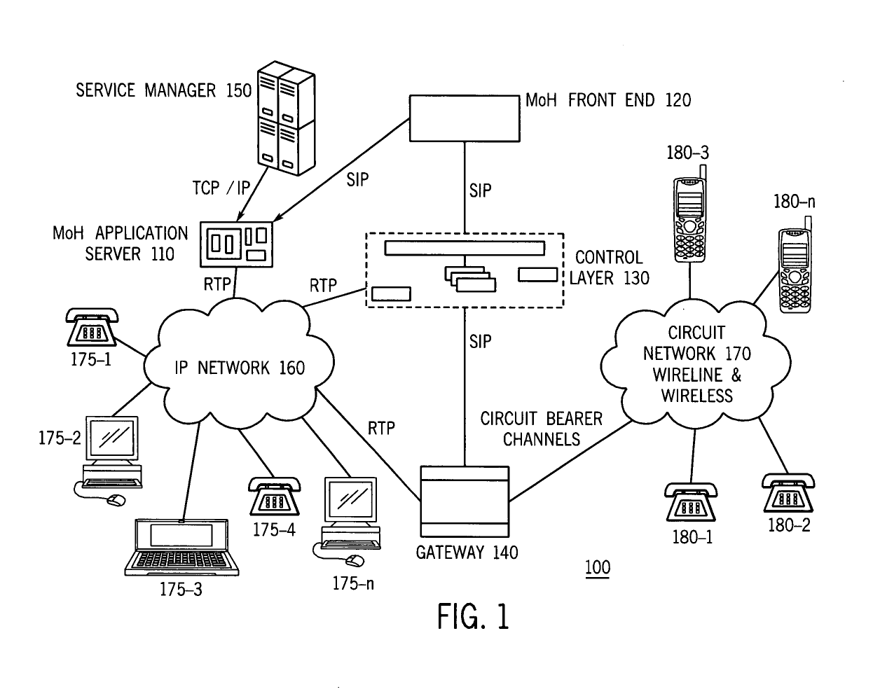

FIG. 1 is a diagram illustrating the network-based personalized music on hold system arranged in accordance with the principles of the invention. As shown in FIG. 1, the personalized music on hold system 100 includes MoH Application Server 110, MoH Front End 120, Control Layer 130, Gateway 140, Services manager 150, IP Network 160, and Circuit Network 170. Also shown are Session Initiation Protocol (SIP)-enabled devices 175-1 to 175-n and wireline and wireless callers 180-1 to 180-n.

MoH Application Server 110 is one or more of an application server that provides a MoH selection, e.g., a music clip, to a caller when the caller has been placed on hold by a MoH subscriber that uses personalized music on hold system 100. In one embodiment of the invention, MoH Application Server 110 is invoked to obtain the MoH selection chosen by the MoH subscriber for the caller on hold when the MoH subscriber presses a service access code, e.g., *98, on a telephone during a telephone conversation. In another embodiment of the invention, MoH Application Server 110 is invoked to obtain the MoH selection chosen by the MoH subscriber for the caller when the MoH subscriber places the caller on hold to answer a Call Waiting service call. In yet another embodiment of the invention, MoH Application Server 110 is invoked to obtain the MoH selection chosen by the MoH subscriber for the caller when a Session Description Protocol (SDP) offer transmitted from the MoH subscriber's telephone contains a request to put a session on hold.

MoH Application Server 110 accesses a stored profile and determines the MoH selection based on an interest of the caller maintained in the profile. MoH Application Server 110 signals MoH Front End 120 to transmit the MoH selection to the caller's telephone, and to play the MoH selection during the silent period of the call while the caller is placed on hold by the MoH subscriber. In one embodiment of the invention, the MoH subscriber may press a second service access code, e.g., *99, on any telephone to invoke MoH Application Server 110 to terminate the MoH selection when the MoH subscriber is ready to resume the conversation with caller. In another embodiment of the invention, the MoH subscriber pivots from the Call Waiting service call to the caller to terminate the MoH selection. In yet another embodiment of the invention, the MoH selection is terminated when a SDP offer transmitted from the MoH subscriber's telephone contains a request to retrieve the call from on hold.

Optionally, MoH Application Server 110 allows callers receiving music while on hold to change characteristics of the music, e.g., increase or decrease volume, pause, deactivate or activate the MoH selection, by pressing a dual tone multi-frequency (DTMF) key on their telephone.

When implemented in a network, such as an IP Multimeda Subsystem (IMS), as will be appreciated by those skilled in the art, one or more of MoH Application Server 110 may serve hundreds or thousands of users of personalized music on hold system 100 within a given area. MoH Application 110 is connected to MoH Front End 120 via a SIP interface, Services manager 150 via a Transmission Control Protocol/Internet Protocol (TCP/IP) interface, and IP Network 160 via a Real Time Protocol (RTP) interface. MoH Application 110, in one embodiment, comprises one or more of an Enhanced Media Resource Server (eMRS) (Lucent Technologies).

MoH Front End 120 is one or more of an application server that manipulates a call path between callers and MoH Application Server 110. More specifically, MoH Front End 120 determines when a caller has been placed on hold by the MoH subscriber that uses personalized music on hold system 100. In one embodiment of the invention, MoH Front End 120 determines when a caller has been placed on hold based on an evaluation of the DTMF signals received when the MoH subscriber presses the first service access code, e.g., *98. In another embodiment of the invention, MoH Front End 120 determines when the caller has been placed on hold when the MoH subscriber answers a Call Waiting service call. In yet another embodiment of the invention, MoH Front End 120 determines when the caller has been placed on hold by determining whether a Session Description Protocol (SDP) offer transmitted from the MoH subscriber's telephone contains a request to put a session on hold. Upon determining that the MoH subscriber has placed the caller on hold, MoH Front End 120 transmits a request to MoH Application Server 110 to find an appropriate MoH selection to play during the silent period while the caller is on hold. When MoH Application Server 110 finds the MoH selection, then MoH Front End 120 transmits the MoH selection to the caller.

Upon determining that the caller is no longer on hold, MoH Front End 120 transmits a request to MoH Application Server 110 to terminate the music. In one embodiment of the invention, MoH Front End 120 determines that the caller is no long on hold based on an evaluation of the DTMF signals received when the MoH subscriber presses the second service access code, e.g., *99. In another embodiment of the invention, MoH Front End 120 determines that the caller is no long on hold when the MoH subscriber pivots from the Call Waiting service call to the caller. In yet another embodiment of the invention, MoH Front End 120 determines that the caller is no long on hold when a SDP offer transmitted from the MoH subscriber's telephone contains a request to retrieve the call from on hold.

MoH Front End 120 is connected to MoH Application Server 110 and Control Layer 130 120 via SIP interfaces. MoH Front End 120, in one embodiment, comprises one or more of a Feature Server 5000 (Lucent Technologies).

Control Layer 130 provides network control for voice and data services. Control Layer 130 performs communication session set up, tear down, coordination and blending of multimedia services. Control Layer 130 is connected to MoH Front End 120 and Gateway 140 via SIP interfaces, and IP Network 160 via a RTP interface. Control Layer 130, in one embodiment, comprises one or more of an Session Control Layer (Lucent Technologies).

Gateway 140 bridges both traditional circuit networks and Internet Protocol (IP) networks by providing translations between IP network and circuit network transport protocols. Gateway 140 passes bearer traffic among public switched telephone network (PSTN) and IP networks for SIP-enabled devices and wireline and wireless callers. Gateway 140 is bearer protocol agnostic, supporting a wide variety of time division multiplexing (TDM), voice over IP (VoIP) and wireless applications. Gateway 140 is connected to Control Layer 130 via a SIP interface, IP network 160 via a RTP interface, and circuit network 170 via circuit bearer channels. Gateway 140, in one embodiment, comprises one or more of a Lucent Network Gateway (Lucent Technologies).

Services manager 150 is a management system that provides operations, administration, maintenance and provisioning (OAM&P) support for MoH Application Server 110. Services manager 150 assists the MoH subscriber that uses personalized music on hold system 100 in configuring, i.e., creating, editing, and updating, etc., a stored profile. The MoH subscriber configures the stored profile to a) determine what music to play, i.e., a MoH selection, when callers are placed on hold and b) impose conditions for when to play specific MoH selections. The MoH subscriber may access their account via an Internet web portal tool to Services manager 150 in order to configure profiles maintained by the MoH subscriber. The Internet web portal tool may be a personal computer that allows access to Services manager 150's software configuration data. Upon accessing the account, the MoH subscriber may, illustratively, configure a profile for a caller A to play song #1 when caller A has been placed on hold. Also illustratively, the MoH subscriber may configure a profile for a caller B to play song #2 when caller B has been placed on hold on any Monday. Further illustratively, the MoH subscriber may configure a profile for anyone from the New York Yankees baseball team to play song #3 when anyone from the New York Yankees baseball team has been placed on hold.

In some instances, the MoH subscriber may desire to configure personalized music on hold system 100 to deactive the music on a per call basis. Illustratively, the MoH subscriber may desire to deactive the music on hold during a conference call in which one or more conferees may be placed on hold.

Services manager 150 is connected to MoH Application Server 110 via a TCP/IP interface. Services manager 150, in one embodiment, comprises one or more of an Enhanced Services Manager (eSM) (Lucent Technologies).

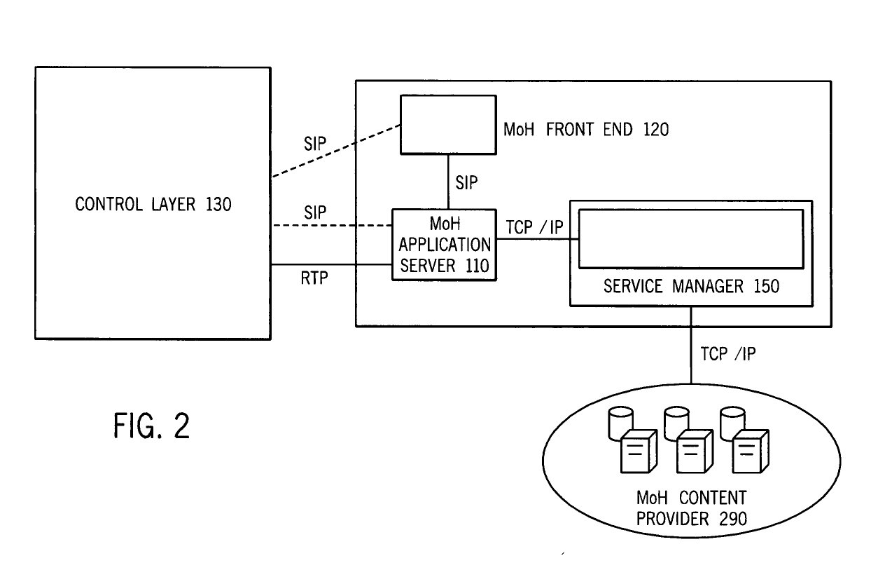

FIG. 2 shows another network view of an illustrative embodiment of personalized music on hold system 100. In addition to MoH Application Server 110 interfaces as shown in FIG. 1, FIG. 2 shows a connection to Services Manager 150 from MoH Content Provider 290. MoH Content Provider 290 may be a commercial provider of music clips to businesses using music on hold systems. In FIG. 2, Services manager 150 receives a download of music clips from MoH Content Provider 290 via a TCP/IP interface, and Services manager 150 transmits the music clips to MoH Application Server 110 for storage.

Those of ordinary skill in the art will readily be able to select application servers, Control Layers, and gateways appropriate for use in any particular implementation of the personalized music on hold system 100.

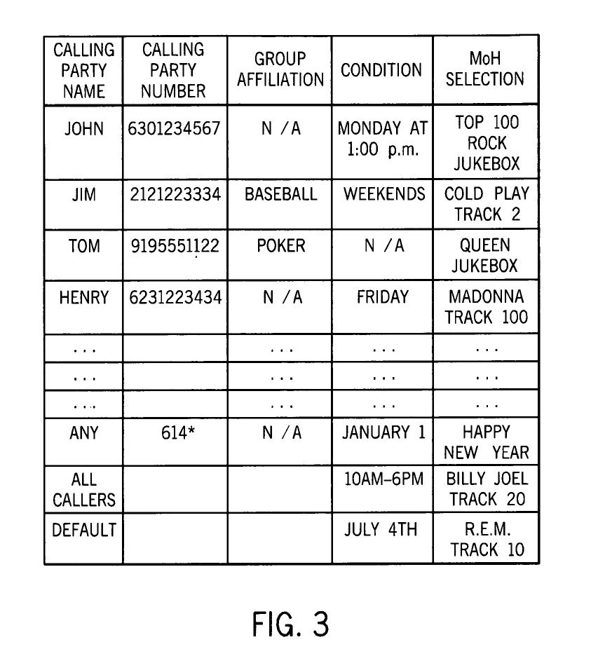

FIG. 3 shows an illustrative profile of callers to a business that is a user of personalized music on hold system 100. The structure of the profile may vary depending on a particular implementation of the profile. Each row of the profile represents a stored record for a particular caller. Each column of the profile represents specific attributes of each record.

A first column of the profile may provide a name of the callers. The name of the callers may be the name of a business, the name of an individual, or a default assignment. The length of the name may be limited to a predetermined width of the column.

A second column of the profile may provide a telephone number of the callers.

A third column of the profile may provide an affiliation of the callers, such as a hobby, a favorite sport, or an employer.

A fourth column of the profile may provide a condition for transmitting a music on hold selection to the callers. The condition may include a date, a time interval, e.g., between 8:00 a.m. and 10:00 a.m., a specific day and time, e.g., Monday at 1:00 p.m., or an area code of each caller.

A fifth column of the profile may provide and identify a music on hold (MoH) selection that may be based on an interest of the callers chosen by the MoH subscriber that uses personalized music on hold system 100. Also, the MoH selection chosen by the MoH subscriber may be used as a technique for distinguishing between callers. Illustratively, callers from different area codes may have different MoH selections. Also, illustratively, callers from the same employer or the same interest group may have the same MoH selections. The MoH selection may be a) at least one song title, b) at least one musical artist, c) at least one musical group, d) at least one music genre, or e) a random song selection. Optionally, the music on hold selection may be pre-selected by the caller.

The profile may be stored in MoH Application Server 110 and the profile may be administered by Services manager 150. The telephone number of the caller and the telephone number of the MoH subscriber may be used as a unique identifier to access a particular record of a caller. Records used to populate the profile may be provided from a customer directory if the MoH subscriber is a business subscriber or a telephone address book if the MoH subscriber is a residential subscriber.

Advantageously, personalized music on hold system 100 plays music selected for specific callers by the MoH subscriber to personalize the listening experience of the specific callers. The MoH subscriber may be a business or residential subscriber. Also advantageously, MoH subscribers using personalized music on hold system 100 can distinguish between callers on hold with the music selections. Further advantageously, the existence of a network connection to the callers on hold means that the connection between the MoH subscriber and MoH Application Server 110 can be completely dropped. Thus, the MoH subscriber using personalized music on hold system 100 may hang up the telephone, leaving the callers on hold listening to the MoH selection. This situation may benefit businesses with leased line connections, because the businesses may be able to accommodate more simultaneous calls per hour without using additional ports on a PBX.

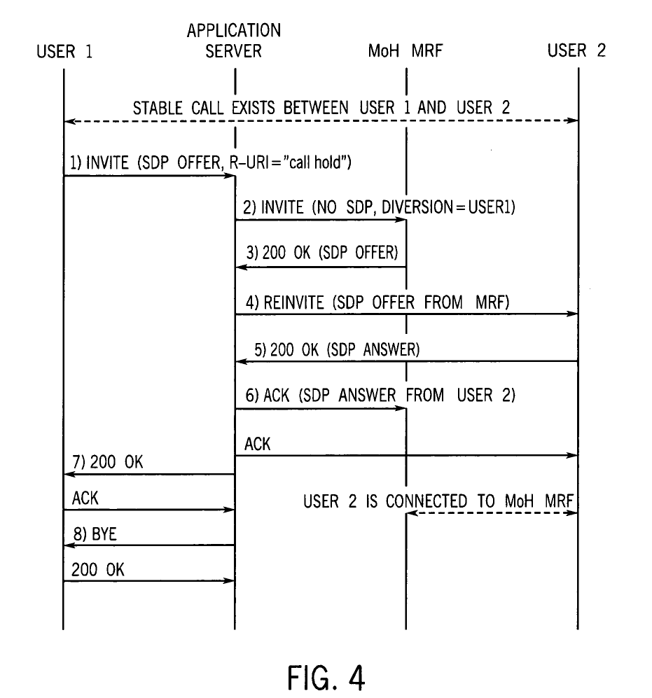

FIG. 4 shows an illustrative call flow of the operation of personalized music on hold system 100 in accordance with the principles of the present invention. User 1, a MoH subscriber using personalized music on hold system 100, places User 2, a telephone caller, on hold during a telephone conversation.

At 1, User 1 uses a hook-flash on a telephone and dials a “call hold” service access code, e.g., *98. User 1's customer provided equipment (CPE) transmits an INVITE request to an application server, e.g., MoH Application Server 110 (FIG. 1).

At 2 (FIG. 4), the application server transmits an INVITE request to a MoH Media Resource Function (MoH MRF), e.g., MoH Content Provider 290 (FIG. 2) that will provide an audio source to User 2. The INVITE (FIG. 4) has a SIP Diversion header that includes the identification of User 1 and User 2.

At 3, the MoH MRF selects a User Datagram Protocol (UDP) port and IP address, and transmits this information in a Session Description Protocol (SDP) offer as part of a 200 OK response. The SDP offer is the method for negotiating the bearer path characteristics.

At 4, the application server transmits a REINVITE request to User 2. The SDP offer received from the MoH MRF is included in the REINVITE request.

At 5, User 2's CPE transmits a SDP answer as part of a 200 OK response.

At 6, the SDP answer received from User 2 is transmitted in an ACK response to the MoH MRF, and a bearer path is now established between the MoH MRF and User 2. User 2 now hears the music supplied by the MoH MRF.

At 7, the application server will confirm the INVITE request transmitted by User 1 by transmitting a 200 OK response.

At 8, the application server transmits a BYE response to User 1 terminating the dialog. User 1 can now hang up the telephone, leaving User 2 on hold listening to the MoH selection.

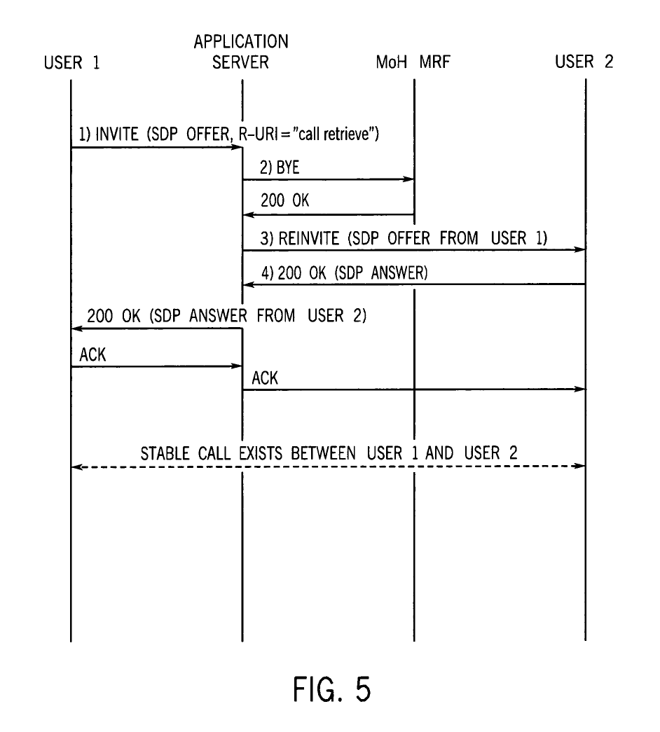

FIG. 5 shows another illustrative call flow of the operation of personalized music on hold system 100 in accordance with the principles of the present invention. User 1, a MoH subscriber using personalized music on hold system 100, retrieves User 2, a telephone caller, from hold during a telephone conversation.

At 1, User 1 dials a “call retrieve” service access code, e.g., *99, from any telephone to retrieve the call on hold. User 1's CPE transmits an INVITE request to an application server, e.g., MoH Application Server 110 (FIG. 1).

At 2 (FIG. 5), the application server transmits a BYE request to the MoH Media Resource Function (MoH MRF), e.g., MoH Content Provider 290 (FIG. 2), to terminate the music.

At 3 (FIG. 5), the application server transmits a REINVITE request to User 2. The REINVITE request includes the SDP offer (FIG. 4) received from User 1.

At 4 (FIG. 5), User 2's CPE transmits an SDP answer in a 200 OK, and a bearer path is reestablished between User 1 and User 2, which allows User 1 and User 2 to resume their conversation.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. A method, comprising the steps of:
generating, during a silent period of a telephone call when a first telephone user has been placed on hold by a second telephone user, music for the first telephone user selected by the second telephone user based on a musical interest of the first telephone user; and
terminating the music when the first telephone user is no longer on hold.

2. The method of claim 1 wherein a stored profile contains the musical interest of the first telephone user.

3. The method of claim 2 wherein the stored profile comprises a) a name of the first telephone user, b) a telephone number of the first telephone user, c) an affiliation of the first telephone user, d) the musical interest of the first telephone user, and e) at least one condition for transmitting the music.

4. The method of claim 1 wherein the musical interest is selected from the group consisting of a) at least one song title, b) at least one musical artist, c) at least one musical group, d) at least one music genre, and e) at least one random song selection.

5. The method of claim 3 wherein the at least one condition for transmitting the music is selected from the group consisting of a) a date, b) a time interval, c) a day and time, and d) an area code of the first telephone user.

6. The method of claim 1 wherein the generating step further comprises the steps of:
determining when the first telephone user has been placed on hold;
accessing a stored profile as a function of an identifier;
identifying, in the stored profile, the musical interest of the first telephone user;
retrieving the music based on the musical interest; and
transmitting the music to the first telephone user during the silent period of the call when the first telephone user has been placed on hold.

7. The method of claim 6 wherein the determining step further comprises the step of evaluating a first received service access code to determine when the first telephone user has been placed on hold.

8. The method of claim 6 wherein the determining step further comprises the step of determining whether a Session Description Protocol (SDP) offer transmitted from the second telephone user contains a request to put a session on hold.

9. The method of claim 6 wherein the determining step further comprises the step of determining when the second telephone user has answered a Call Waiting service call.

10. The method of claim 6 wherein the identifier is a telephone number of the first telephone user and a telephone number of the second telephone user.

11. The method of claim 1 wherein the terminating step further comprises the step of evaluating a second received service access code to determine when to terminate the music.

12. The method of claim 1 wherein the terminating step further comprises the step of determining whether a Session Description Protocol (SDP) offer transmitted from the second telephone user contains a request to retrieve the call from on hold.

13. The method of claim 2 wherein the second telephone user accesses an account of the second telephone user, configures a profile, and saves the profile as the stored profile prior to the generating step.

14. The method of claim 13 wherein the second telephone user configures the profile to a) determine what music to play when the first telephone user has been placed on hold and b) impose conditions for when to play the music.

15. The method of claim 1 wherein the first telephone user elects to deactivate the music prior to the terminating step by pressing a dual tone multi-frequency (DTMF) key on a telephone of the first telephone user.

16. The method of claim 1 wherein the second telephone user terminates a connection to the first telephone user while the first telephone user continues to listen to the music.

17. An apparatus, comprising:
means for generating, during a silent period of a call when a first telephone user has been placed on hold by a second telephone user, music for the first telephone user selected by the second telephone user based on a musical interest of the first telephone user; and
means for terminating the music when the first telephone user is no longer on hold.

18. The apparatus of claim 17 wherein a stored profile contains the musical interest of the first telephone user.

19. The apparatus of claim 18 wherein the stored profile comprises a) a name of the first telephone user, b) a telephone number of the first telephone user, c) an affiliation of the first telephone user, d) the musical interest of the first telephone user, and e) at least one condition for transmitting the music.

20. The apparatus of claim 17 wherein the musical interest is selected from the group consisting of a) at least one song title, b) at least one musical artist, c) at least one musical group, d) at least one music genre, and e) at least one random song selection.

21. The apparatus of claim 19 wherein the at least one condition for transmitting the music is selected from the group consisting of a) a date, b) a time interval, c) a day and time, and d) an area code of the first telephone user.

22. The apparatus of claim 17 wherein the means for generating further comprises:
means for determining when the first telephone user has been placed on hold;
means for accessing a stored profile as a function of an identifier;
means for identifying, in the stored profile, the musical interest of the first telephone user;
means for retrieving the music based on the musical interest; and
means for transmitting the music to the first telephone user during the silent period of the call when the first telephone user has been placed on hold.

23. The apparatus of claim 22 wherein the means for determining evaluates a first received service access code to determine when the first telephone user has been placed on hold.

24. The apparatus of claim 22 wherein the means for determining determines whether a Session Description Protocol (SDP) offer transmitted from the second telephone user contains a request to put a session on hold.

25. The apparatus of claim 22 wherein the identifier is a telephone number of the first telephone user and a telephone number of the second telephone user.

26. The apparatus of claim 17 wherein the means for terminating evaluates a second received service access code to determine when to terminate the music.

27. The apparatus of claim 17 wherein the means for terminating determines whether a Session Description Protocol (SDP) offer transmitted from the second telephone user contains a request to retrieve the call from on hold.

28. A method of operating a network-based personalized music on hold system to generate music for one or more callers placed on hold by a called party, wherein the music is selected by the called party based on musical interests of the one or more callers, the method comprising the steps of:
determining when the one or more callers have been placed on hold;
accessing stored profiles as a function of at least one identifier;
determining, from the stored profiles, the musical interests of the one or more callers;
retrieving the music based on the musical interests of the one or more callers;
transmitting the music to the one or more callers when the one or more callers have been placed on hold; and
terminating the music when the one or more callers are no longer on hold.

29. A network, comprising:
a first application server operable to generate music for one or more callers when the one or more callers have been placed on hold by a called party, wherein the music is selected by the called party based on an interest of the callers; and
a second application server coupled to the first application server, wherein the second application server determines when the one or more callers have been placed on hold and when the one or more callers are no longer on hold.

30. The network of claim 29 further comprising:
a management system coupled to the first application server, wherein the management system allows the called party to configure profiles with the interest of the one or more callers;
a control layer coupled to the second application server, wherein the control layer provides network control for voice and data services; and
a gateway coupled to the control layer, wherein the gateway passes bearer traffic among a public switched telephone network (PSTN) and IP networks for SIP-enabled devices, wireline callers and wireless callers.
